(19) United States
(12) Patent Application Publication
(10) Pub. No.: US 2008/0135706 A1
(43) Pub. Date: Jun. 12, 2008

(54) System For Mounting of a Venetian Blind

(75) Inventor: Torben Meyer Andersen, Svendborg (DK)

Correspondence Address: DARBY & DARBY P.C., P.O. BOX 770, Church Street Station, New York, NY, 10008-0770, US

(73) Assignee: FABER A/S, Ryslinge (DK)

(21) Appl. No.: 11/722,800

(22) PCT Filed: Jan. 11, 2006
(86) PCT No.: PCT/DK2006/000018

§ 371 Date: Aug. 15, 2007

(30) Foreign Application Priority Data
Jan. 12, 2005 (DK) BA 2005 00012

(51) Int. Cl. A47H 1/14; E06B 9/323

(52) U.S. Cl. 248/251

(57) ABSTRACT

The present invention relates to a system for mounting of a Venetian blind or the like on a building part, said system comprising: a mounting rail with a longitudinally extending passage being delimited in the longitudinal direction by a first edge and a second edge and configured for accommodating a pull mechanism for the Venetian blind, a suspension fitting with a movable part; and wherein the suspension fitting is configured as a relatively flat element with a fore edge, a rear edge, an underside, and a longitudinal expanse delimited by end edges; and configured with means for attachment of the suspension fitting on the building part; and wherein the suspension fitting comprises a downwardly oriented side flange with a protruding part extending in a direction away from the fore edge and is configured with an upwardly open cut-out for receiving a downwardly oriented fold on the second edge of the mounting rail, and wherein the movable part is provided with engagement means for engagement with the first edge of the rail. Hereby an improved suspension fitting is accomplished by which it is avoided that the mounting rail leaves its engagement with the suspension fitting and falls down during operation.

The present invention relates to a system for mounting of a Venetian blind or the like on a building part.

Various varieties of suspension fittings are known and they serve to secure the mounting rail of the Venetian blind onto a building part. The mounting rail is of the kind that serves to suspend the Venetian blind and to accommodate the winding and adjustment mechanism by which the lamellae of the blind are caused to change inclination and by which the stack of lamellae can thus be pulled upwards. Moreover the suspension fitting could be used for other types of window shieldings that comprise a mounting rail for mounting at an upper part of an opening in a building wall.

For instance from US 2001/0007344 suspension fittings for mounting of a Venetian blind or the like on a building part are known. By that solution a downwardly oriented edge on the mounting rail is mounted for engagement with a fixed protruding part on the suspension fitting; and a second downwardly oriented edge on the mounting rail is secured in snap-locking engagement with a spring-biased, movable part.

U.S. Pat. No. 4,949,926 teaches a further suspension fitting for mounting of a U-shaped suspension rail for a Venetian blind on a building part.

It is a problem of the solution taught therein that precisely only the second edge on the mounting rail is secured by a spring-biased, movable part, the suspension rail not allowing sudden pulls/movements during operation when the Venetian blind is pulled upwards without an ensuing risk of the mounting rail disengaging from the suspension fitting and falling down during operation. By the present invention an improved suspension fitting is provided whereby it is possible to widely obviate said problems when the Venetian blind is operated. This problem is solved by the invention according to the characterising part of claim 1.

Advantageous embodiments of the invention will appear from the dependent subclaims.

In the following the invention will be described in further detail with reference to the drawing, wherein:

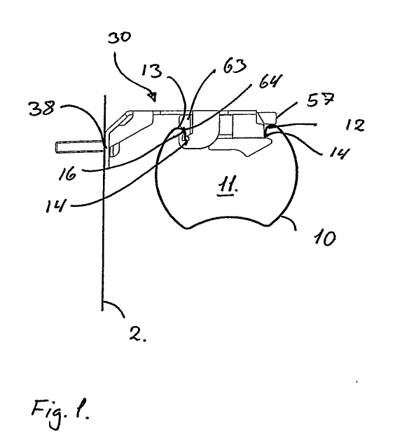

FIG. 1 is a lateral view of a suspension fitting on which a mounting rail is mounted; and

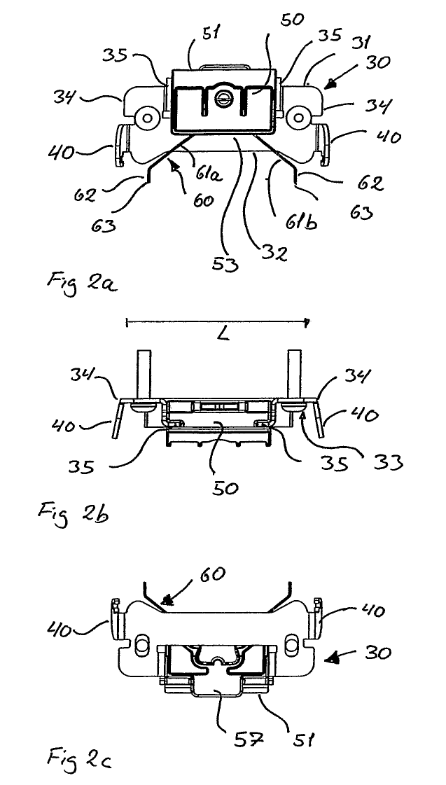

FIGS. 2a-d show a suspension fitting seen from different sides; and

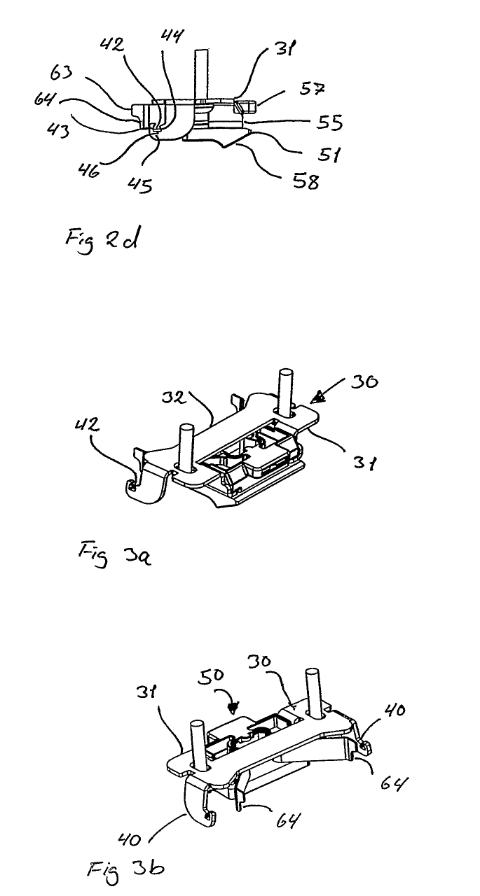

FIGS. 3a-b show suspension fittings in perspective views, seen from two angles.

Thus, FIG. 1 is a cross-sectional view of a mounting rail 10 for mounting of a Venetian blind or the like, said mounting rail 10 being, in the longitudinal direction, delimited by a first edge 12 and a second edge 13. In addition to being intended for suspension of the Venetian blind, the suspension rail 10 is configured for accommodating the operating mechanism associated with the Venetian blind. In the figure the mounting rail 10 is secured by means of a suspension fitting 30, intended for being secured on a not shown building part and preferably in connection with eg a window opening or a door opening. Alternatively the suspension fitting 30 can be secured directly in connection with a window or a door and eg directly onto the frame. Below the suspension fitting 30 will be subject to detailed description.

Now, in the following reference will be made to FIGS. 2a-2d and 3a, 3b, wherein FIG. 2a shows a plane view of the suspension fitting 30 is shown, seen from an underside 33.

The suspension fitting 30 is configured as a relatively flat element with a fore edge 31, a rear edge 32 and a longitudinal expanse (L) which is delimited at end edges 34, from which integrally configured downwardly bent side flanges 40 extend in a direction away from the underside 33. As will appear in particular from FIG. 2d, in a direction away from the fore edge 31, a protruding part 45 extends from each of the side flanges 40, each protruding part 45 being configured with an upwardly open cut-out 42 for receiving a downwardly oriented folding 14 on the first or second edge 12, 13 of the mounting rail.

From FIG. 2d it appears particularly clearly that the upwardly open cut-out 42 is delimited by a first side 43, a second side 44 and a bottom face 46, wherein said first side 43 extends higher up from the bottom face 46 than said second side 44. Hereby a hook-like part is provided, where the upwardly open cut-out 42 is configured with a fit that allows a certain movement of the edge 12, 13 of the mounting rail.

In the following reference is made in particular to FIGS. 2a and 2b, from where it will appear that the suspension fitting 30 is configured with guide rails 35 that extend perpendicularly to the longitudinal expanse (L) of the suspension fitting 30 and also in a plane in parallel with the underside 33 and thus defines a shifting plane.

Guide rails 35 are configured for conveying a movable part 50 with a fore edge 51 and a rear edge 53, from which rear edge 53 a spring means 60 extends transversally to the longitudinal direction and is configured with an edge delimitation 63 which is configured for cooperating with the other edge 13 on the mounting rail 10 for providing a squeeze for securing the mounting rail in engagement with the suspension fitting 30.

At the fore edge 51, the movable part is provided with a longitudinally extending cut-out 55 that serves to cooperate with an edge 12 or 13 on the mounting rail 10 for establishment of a snap-connection. Above the cut-out, the movable part is configured with a protrusion 57 that extends in the shifting plane before the fore edge 51 and, when the movable part 50 snap-lockingly engages with the first edge 12 on the mounting rail 10, extends above the first edge 12 on the mounting rail 10. The movable part 50 is configured with a downwardly oriented inclining face 58 that extends underneath the cut-out 55 and forms an acute angle relative to the fore edge 5. Protrusion 57 is configured for operation of the movable part 50, and in the context of that it will be understood that, eg by means of a screw driver, it will be possible to release the snap-locking engagement between the suspension fitting 30 and the mounting rail 10, the protrusion 57 being otherwise essentially hidden by the mounting rail 10 when mounted on the suspension rail 30. Preferably the movable part 50 is manufactured from a transparent material.

The spring means 60 is configured with two legs 61a, 61b that extend centrally from the rear edge 53 at an angle in relation thereto. The spring means 60 has a course that comprises an edge delimitation 63 with an abutment face, said abutment face extending essentially perpendicular to the underside 33. The edge delimitation 63 comprises a concave downwardly oriented corner face 64 configured for cooperating with a side face 16 on the downwardly oriented fold 14 on the second edge 13 of the mounting rail 10.

As will appear particularly clearly from FIG. 1, an attachment is established of the second edge 13 of the mounting rail 10 in the cut-out 42 at the point of engagement of the concave, downwardly oriented corner face 64 with the side face 16 on the downwardly oriented fold 14. This attachment is provided by the downwardly oriented fold 14 being pressed toward the side 43 of the cut-out 42 by compression/shifting of the spring means 60 in the shifting plane (horizontal direction). Likewise an attachment is established of said second edge 13 perpendicular to or essentially perpendicular to the shifting plane (vertical direction), said concave downwardly oriented corner face 64 exerting a force in the vertical direction on the side face 16 and also prevents a movement of the mounting rail 10/the second edge 13 perpendicularly to shifting plane (in vertical direction).

The first edge 12 of the mounting rail 10 is secured against movement transversally of the shifting plane (in vertical direction) by snap-lockingly engaging the recess 55 in the movable part 50.

A particularly efficient attachment of the mounting rail is accomplished in that the movable part 50 and the spring means 60 are connected to each other and that they both establish a direct engagement with each their edge 12, 13 on the mounting rail 10. In that respect certain degrees of freedom are also ensured when the mounting rail 10 is mounted on the suspension rail 30, since minor angulations between the suspension rail 30 and the suspension rail 10 are absorbed by the dependent movement of the movable part 50/the spring means 60 relative to each other. Precisely the mutually connected legs 61a, 61b of the spring means 60 are particularly advantageous; ensuring simultaneously, by their abutment directly onto the edge 13 of the mounting rail 10, a persistent squeeze between mounting rail and the movable part 50/spring means 60 and its abutment faces.

Precisely by the mounting rail 10 being secured by a movable part 50, where the spring means 60 acts directly onto the edge 13/sideface 16 of the mounting rail, it is accomplished that the movable part 50 and the spring means 60 will essentially follow a movement, if any, of the mounting rail 10 during operation of the Venetian blind. Thus, the movable part 50 and the spring means 60 describe a system that cooperates and adapts to an external force. Hereby it is enabled that the movable part 50 will remain in snap-locking engagement with the edge 12, and that the force established by the spring means 60 remains unchanged. It will simultaneously be understood that, in an extreme scenario where the edge 12 leaves its snap-locking engagement with the recess 55 during the operating procedure, the edge 13 of the mounting rail will be secured in the upwardly oriented cut-out 42, and therefore the mounting rail with Venetian blind is prevented from falling down.

Reference is made again to FIG. 1 where the suspension fitting 30 is shown with a rear flange 38 that extends from a rear edge 32 on the suspension fitting 30, which rear edge 32 extends in parallel with the longitudinal expanse (L). The rear flange 38 is configured with a course that extends perpendicularly to the underside 33 of the suspension fitting 30 across a portion of the rear flange 38 and is configured with means for securing the suspension fitting 30 on a vertical face 2.

1. A system for mounting of a Venetian blind or the like on a building part, said system comprising:
a mounting rail with a longitudinally extending passage being, in the longitudinal direction, delimited by a first edge and a second edge and configured for accommodating a pull mechanism for the Venetian blind;
a suspension fitting with a movable part;
said suspension fitting being configured as a relatively flat element with a fore edge, a rear edge, an underside and a longitudinal expanse delimited by end edges and configured with means for attachment of the suspension fitting on the building part;
wherein the suspension fitting comprises two downwardly oriented side flanges with a protruding part extending in a direction away from the fore edge and configured with an upwardly open cut-out for receiving a downwardly oriented fold on the second edge of the mounting rail;
and wherein the movable part is provided with engagement means for engaging with the first edge of the rail, wherein the movable part comprises a spring means that extends transversally of the longitudinal direction; and wherein an edge delimitation on the spring means is configured for cooperating with the second edge on the mounting rail for providing a squeeze for securing the mounting rail in engagement with the suspension fitting.

2. A system according to claim 1, wherein the rear side of the said movable part is connected to a spring means configured with two legs that extend transversally of the longitudinal direction and comprising at each end an edge delimitation, by which an abutment face is provided which is configured for transferring an applied squeeze from the spring means to the second edge of the mounting rail.

3. A system according to claim 1, wherein the edge delimitation is configured with a concave downwardly oriented corner face configured for cooperating with a side face on said downwardly oriented fold for establishing an attachment between the suspension fitting 30 and the mounting rail.

4. A system according to claim 1, wherein, from each end edge on the suspension rail 30), a downwardly oriented side flange extends in a direction away from the underside, wherein said side flange comprises means for securing the second edge of the mounting; and wherein, in a plane in parallel with the underside, a pair of guide rails is provided for guiding the movable part perpendicularly to the longitudinal expanse.

5. A system according to claim 1, wherein the movable part comprises a front side and a rear side, wherein said front side is configured with means for establishing a snap-engagement of the movable part and the first edge on the mounting rail.

6. A system according to claim 1, wherein said front side on the movable part is configured with a longitudinally extending recess for being received by the first edge on the mounting rail, whereby, following receipt of the second edge of the mounting rail and following receipt of the first edge on the mounting rail in said longitudinally extending recess, the mounting rail is secured against movement in a vertical plane, said system also allowing a certain movement in a horizontal plane between the suspension fitting and the mounting rail.

7. A system according to claim 1, wherein said downwardly oriented cut-out is delimited by a first side, a second side and a bottom face, where said first side extends higher up from the bottom face than said second side.

8. A system according claim 1, wherein said front side of the movable part is configured with an downwardly tapering face that forms an acute angle relative to the front side.

9. A system according to claim 1, wherein said front side of the movable part comprises a protrusion which, when the movable party snap-lockingly engages the first edge on the mounting rail, extends above the first edge on the mounting rail.

10. A system according to claim 1, wherein the suspension fitting comprises a rear flange that extends from the rear edge of the suspension fitting, said rear flange being configured with a course that extends perpendicularly to the underside of the suspension fitting across a portion of the rear flange and is configured with means for attachment of the suspension fitting on a vertical face.
